(19) United States
(12) Patent Application Publication
(10) Pub. No.: US 2008/0281794 A1
(43) Pub. Date: Nov. 13, 2008

(54) "Web 2.0 information search and presentation" with "consumer == author" and "dynamic Information relevance" models delivered to "mobile and web consumers".

(76) Inventor: Anup K. Mathur, Sunnyvale, CA (US)

Correspondence Address: Anup K. Mathur, 1731 Chitamook Ct., Sunnyvale, CA, 94087, US

(21) Appl. No.: 12/043,937

(22) Filed: Mar. 6, 2008

Related U.S. Application Data
(60) Provisional application No. 60/893,223, filed on Mar. 6, 2007.

(51) Int. Cl. G06F 17/30

(52) U.S. Cl. 707/3; 707/E17.108

(57) ABSTRACT

Moving forward from current generation of search engines, originally designed for web 1.0, an entirely new comprehensive information search system is presented for searching and presenting of information in the Web 2.0, and other emerging new models of the global Internet using new and emerging sources of static and dynamic information, including but not limited to professionally created web pages, consumer created content, increasingly dynamic yet invisible web or web services based web, unconnected yet relevant dark web, mobile content web, social networked web and other emerging models of content publication, with access using mobile and fixed wireless and wire-line networked computing, communication and entertainment devices, user agents and application agents, and corresponding new business and delivery models for consumer and business users worldwide through sponsored web business model, content advertising business models, keyword advertising models, multi-media advertising models or pay per search, pre-paid and service business models.

This application is related to and claims priority under 35 U.S.C. §119(e) to a commonly assigned provisional patent application entitled “Web 2.0 information search and presentation with Consumer==Author and Dynamic Information Relevance models delivered to Mobile and Web Consumers through Sponsored Web and Global Keywords business methods” by Anup K. Mathur, Application Ser. No. 60/893,223 filed on Mar. 6, 2007.

### BACKGROUND OF INVENTION

Search technology as per state of the art today, relies upon web capture software (Web Crawler Model) assembling a database view of the web as it evolves and in the process creating a lookup system based on words and corresponding web pages which contain such words (also known as Inverted Index Table Model). The inverted index table is constantly updated as new web pages or new versions of existing web pages are gathered by Web Crawlers running 24×7 across the global Internet.

Given a search word by consumer, the system looks up the inverted index table for corresponding web pages and presents these in a specific order. In case of a market leading offering, such an order is pre-decided statically, using the number of important web pages that link to the target web page, giving assessment of global static rank of the web page and hence consider it more relevant (also known as Relevance Model).

Today's web has already reached more than 3 Billion web pages, and around 10 Million words, where search engines service millions of customers at the same time, by achieving parallelism of search across users through load balanced arrays of servers (Parallelization Model), computing this lookup and returning the most relevant results.

To create revenue, the keywords are used for looking up a corresponding banner advertisements or sponsored links (Advertising and Sponsorship Model), and these are presented to user along side main search results; and hence for every click through of a sponsored link by user, the search engine gets paid small amount of money by the sponsored link site or customer i.e. creating the paid search model and measured by Cost-Per-Click through or CPK. Paid Search results are in some cases based on bid value only, and in some other cases combined with relevance, to present more useful sponsored links to end users. Sponsors typically bid, in auction pricing model, for individual keywords for each click-through of end user of their links, raising the competition amongst sponsors for getting higher visibility in the paid search list presented. Current rates of click-throughs are around 10% for sponsored results with some risk of fake click-throughs.

Marketers are seeing increase in their revenue with increase in their investment in search keywords. Further, the more popular keywords continue to get better results and hence more and more sponsors are increasingly competing for the more popular keywords. Smart marketers with brand name offerings are expected to experiment with not-so-popular keywords taking advantage of the long tail effect in keywords.

With search offerings being free for consumers, on the Internet millions and millions of queries are posed every day,; making advertising or sponsored link the main source of revenue and through this model leads to large revenues reaching billions over a financial year (Revenue Model). The market size is governed by share of Internet advertising which has already reached around $12B in 2006 and is increasing globally in percentage share of overall advertising and marketing budgets of enterprises, which is around $IT globally.

Additionally, search is also responsible for a large percentage of Internet shopping and hence combination solutions of shopping and search command an even bigger market (Internet Shopping Model). This model has the potential to extend itself to Mobile based comparative shopping, a new and promising field (Mobile Search and Shopping Model).

Somewhat unrelated solutions present today are based on users creating their profiles and sharing these with global audience for social purposes (this is called Social Networking); popular sites of this model are MySpace and FaceBook, which have attracted young people to publish their profiles, with photos and videos and hence have become popular. These models involve creation of a social profile by consumers using friendly tools, and in some cases also allowing them to upload HTML and similar scripts directly.

Another aspect of new trends in the web include uploading and sharing of videos and photos (Upload and Share Videos and Photos model) to sites such as YouTube and Google-Video, where users can upload their videos etc. and share with the rest of the world. These sites are server based storage spaces and with some built in search capabilities using text based captions and they also track popularity of content based on how many users have viewed the content; and present most popular videos first. The problem is lack of maturity of the solution which leads to no control of who sees what content, and hence does not service most consumer needs properly. The systems also require users to upload their content, which again is less than desirable, since users would rather see a friendlier solution to this problem. New offerings include ChipBlast which search for Videos on the Internet, including at the video upload sites, but use text as criterion for search results.

Other directions in search include location based searches such as presented by Google Earth and MapQuest towards map oriented search. Shops sponsoring these location based results can post their location, as well as coupons to the site for consumers to take advantage of when they search a location (Location Based Search).

Supplementary solutions in search are desktop search, where solutions exist from Google and Microsoft; which allow searching across a desktop PC, and indexing the e-mails, documents and web pages to present as needed by the end user. This method has not really become popularity due to speed being slow as well as users being sensitive to installing external software that takes significant compute power on their PCs (Desktop Search).

To better understand state of art in web search at the time of filing provisional application in March 2007, reference documents including published patents and application search, snapshot of the day for Wikipedia on Search, and other documents are enclosed.

### BRIEF SUMMARY OF INVENTION

In the new web 2.0 environment, with information being global and consumer centric, and not just professionally created but increasingly consumer created, and available through information source that are not just web pages, but also web services and dynamic web pages, a new search engine model is required and defined here to create higher value for consumers that is delivered over various mobile and fixed form factor devices globally, through highly relevant and global advertising or pay per instance or prepaid applications models.

This summary is considered to be indicative of the invention but not complete description, of the invention as described in description section and with specific definition as in the claims section.

### DESCRIPTION OF INVENTION AND EMBODIMENTS

Following describes the new invention of Web 2.0 information search and presentation:

Web 2.0 information search and presentation is “Multi-media Search” and “Mobile Search” for information and content addressing the new “Consumer =Author” model in “Web 2.0”, with “Static web and Dynamic web” models as well as with “Invisible and Dark Web” models of the web, using “Dynamic Information Relevance” consisting of “Dynamic relevance”, determined by “Context”, “Topic”, “Concept”, “Idea”, “Time”, “Location”, “Appropriateness”, combined with “Static relevance” determined as “Global Popularity Index” for information relevance and prioritization, and additionally and optionally combined with “Personal relevance” and “Collective Wisdom” models with varying computation methods for each of the various web models or information sources, and using “Sponsored Web”, “Global Advertising”, “Concept and Topic Advertising”, “Dark Keywords Advertising”, “Personalized Advertising”, and/or “Pay-Per-Search”, “Pre-Paid” or “Applications service” business models and with providing “Global and local access” models from “Current and new form factor consumer computing, communication and mobile devices” over “Wired, wireless and mobile Internet or other data networks” using “Web browser, mobile web browser, integrated search and navigation user agents, or search based consumer and business applications through a standardized search API or web services API”.

Web 2.0 information search and presentation is provided from “Web Browsers, Web Service Applications, Mobile PCs, Mobile Phones/Smart Phones, Smart TV, Media Center PCs, Tablet PCs, Ultra-Mobile PCs, Automotive PCs, Gaming consoles, handheld gaming consoles, Personal media devices, and other emerging form factor consumer computing and communication devices” including but not limited to “Mobile Search and Search Related Applications Device”. Web 2.0 information search and presentation may use a combination of one or more methods below to provide a richer user experience.

Unified search mechanism for web 2.0 with for static and dynamic multi-media and/or mobile information, consisting of periodic and live acquisition of information, acquisition of references to information, indexing and storage, static and dynamic relevance of information to user queries, preview/snippets and results presentation and user search interface with multi-media, multi-device and multi-access model.

Web 2.0 Information Search and Presentation model following new considerations that go beyond current state of search engines are addressed:

Web 2.0 environment with a newly defined “Consumer =Author” model: The system creates a new opportunity for consumers where consumer created content, web page or information gets equal chance of qualifying through the search relevance process in order for the same to be presented to information seeker.

Web 2.0 environment consisting of static and dynamic web, with increasing role of dynamic web information; where static web is traditional web pages or web 1.0, while dynamic web consisting of “on demand” information, or information available through web services, or consumer created content which has limited life yet high frequency of creation and modification.

Web 2.0 environment consisting of dark web, where a larger number of web pages or content is dark to end users as being relatively unimportant with respect to traditional methods of relevance being used by present day search engines; yet such dark pages often having more interesting information to a specific user or user application.

Relevance of information, from all of the various sources towards a specific context, where consumer web pages may in some cases be more relevant to user query but not pointed to by professional or other important web pages.

Reliability of information, where professional web pages may contain more reliable and verifiable information than consumer web pages may contain.

Reliability of information increasing by way of large consumer base endorsement or professional endorsements or business endorsements for information and content originated by consumers.

Speed of information, where consumer provided information may become available sooner than professionally originated information or analysis of such information by professionals.

Information originators' well intended endeavor to originate meaningful information quickly in a manner where it can be easily disseminated directly as a web page or through other consumers, and so uncovered by other interested consumers (such as photos of an incidence captured using a cell phone, communicated via the Internet by consumers, before professionals can even reach the location).

Information originator's well intentioned reference links in a web page along with anchor words that point to more relevant information related to the present web page.

Information originator's well intentioned short message, text description, keywords, title, subject, headings and other supportive information that help communicate information better to intended recipient.

Consumers having limited patience for information discovery which is limiting on time as well as amount of total information exposed to consumers to enable them to make use of such information.

Consumers having alternate means of finding information, beyond the electronic communication, as in telephonic, television, or human to human means, resulting in obsolescence of information if not delivered quickly and in the right context and at the right time.

Timeliness of information requirement thus leads to most of older web pages on the Internet becoming obsolete and hence of becoming of less importance, even though many links may point to the same.

Thus reducing relative importance of professionally authored newspapers or equivalent in professionally authored web pages, as compared to information that is already uncovered by consumers through information originated by other consumers. (Wireless Internet is uniquely enabling this phenomenon, more than wired Internet did for Web 1.0).

Combining the above considerations in a single method to lead to a more pertinent search and information result in the new Web 2.0 environment than the prevalent and leading alternatives originally defined for Web 1.0.

Time Search—time range and time pre-settings. Time considerations can be entered or selected by users or pre-defined through a field or parameter. Time considerations so provided are used to narrow down the search scope and hence improve relevance of the search results. An extension of this method is to enter natural language or scripting language based time consideration expression, including “last 24 hours”, or similar to reduce search scope to only the content that got created in last 24 hours; or a query may contain a time range such as between 2003 and 2005, which will allow search engine to reduce the search scope to only those documents that were created during the specified period, or produce information pertinent to that time period.

Time Search—“It is about time”; Time is a well established concept in real time systems but present day search engines ignore or do not pay sufficient attention to this crucial parameter. Time at which an information is created and time at which such information is searched for are to be compared against user specified dynamic constraint or preference, and only that subset of web pages is considered for presentation that actually qualify this preference. For example, a user is given the choice to permanently set their search preference to only present information for last 1 year; and for every search that they do, only those web pages are presented in search result that have been created in last one year. Alternate models can be user specifying a time range in the context box (refer to dynamic context model) which is then used by the system to dynamically filter out non-qualifying web pages. Another alternate model is for user to state news since user last checked . . . which will produce only that news which has surfaced since last user query of this type. Similar method extensions can be done for specific situations, such as enterprise applications that search for new material on the same topic, again and again, could utilize this search model to reduce their own work. Results so identified with time search may be presented in relevance order based on other considerations such as static relevance or popularity of web page, and may further be sorted by time, to show latest first within the resulting subset. Such a system ensures that user always sees latest information, and if criterion is not met, no information is presented, which could be valuable i.e., nothing changed since user boarded the flight for example; or alerts could be issued by search engine, when user specified criterion is met and shown automatically through a search user interface. Given our world that changes every instant, with 6 Billion people, 1 Billion cell phone yearly shipments, the content available for every consumer is becoming huge, and time is the key factor in reducing such content to a manageable size that always stays current. Extensions of this model are time ranges such as all web pages created between 1999 and 2000 could be search for; or even earlier time frames resulting in the archiving model for search engine which also results in improved system level efficiencies.

Time Context: Current time vs. time of origination of information is used to determine relevance of results. This comparison can be done using any of the following sub-methods:

Latest results shown first, by recognizing the time sensitive information or data contained in the web page.

Latest results shown first, in time sequence, within a search result.

User specified criterion by entering or selecting or presetting time range of results—last 24 hours, last 3 months, or last 2 years. Results outside this set shall not be shown until criterion is changed. A presetting by user can eliminate much of the web which dates prior to criterion, and hence presents only recently generated relevant content.

Utilizing real time web page update to report changes to a web page in real time; for results of interest, without having to search again. Works in coordination with dynamic web acquisition. This would be the case for dynamic web content web pages such as eBay auction page, stock market trades page etc. where information changes even as user is still viewing it.

User having the option to combine time context with any other system or relevance criterion, specified in this system to come up with more relevant information.

Incremental Time Search—Another extension of the time search method is to search for incremental information of the same query or set of queries since the last search conducted by the user.

Appropriate Search—present results appropriate for age—child friendly search engine. Appropriateness information can be captured through personal relevance model, or by users explicitly entering it as qualifier for a query or by presetting through a user agent. This is done, based on age/parental control and social situations, by comparison of such constraints imposed by information originator vs. actual data available for information consumer or seeker (e.g. try entering “play” in traditional search engines to see the result). A more enhanced implementation of this method can look for pre-defined filters such as inappropriate words, phrases, ideas, concepts and topics and to flag an automatic alert against which actions can be taken. The design of the search system is done in a manner to allow for quick lookup of such words for every web page, and presentation of page to end user is governed by the web page or content passing the filters set by system.

User Context Search—This method attempts to process a query more smartly if user enters a second set of words indicating the topic or context of a query along with the keywords or phrases, through a clearly identified user interface for keywords and context words. For the web pages, context words may be generated automatically, by methods such as identifying set of high frequency non-trivial words, or entered specially by the author during page creation. The new system therefore processes keywords in traditional way but then it extends the method to reduce the set to those that also carry the user context i.e. context words specified by users are member of the web page context words. If no context match is found or no context is entered by user, the method trivializes to keywords join based search model prevailing today. Example of such as search is the word “virus” which in present day search engines nearly always results in computer virus results; by entering or presetting medical or health as the context for current or all queries, users can ensure that biological virus results are shown and not computer virus results. User can specify a context for each search queries from a web, application or mobile user interface along with one or more keywords or terms search where context contains natural language words, set of words, topics of interest, picture or videos of interest, web services of interest etc. containing time, location, topic, numerical reference, multi-media reference etc. to allow more relevant and to the point search and results presentation. User can alternatively allow automatic capture of context to a pre-specified extent, to improve search results where-ever such an automatic capture can be achieved.

Topic and Subject Search—Search by topic or subject in addition to or in place of keywords, by user entering or presetting the topic or topics of interest. In one embodiment, topic is defined as specific field of information and is automatically captured, from every web page. In this embodiment topic is deducted automatically as the highest frequency non-trivial word or set of words in a web page. In an alternate embodiment topic is specified by the author using specific tags such as <topic> or Meta tags with “topic” as the name. While searching, a topic can be entered by user explicitly through a second field, and this is compared with list of topics created by search engine and the associated web pages are combined with keyword based search to improve the relevance of search results. Topics are optional to enter, and such entry defaults to being additional keywords if no match of topic word is found in topic list. Topics eliminate the need to have vertical search engines, which are search engines for specific topics. Topic can also be referred to as subject.

Concept Search—Searching by concept and information and web pages related to a concept, in addition to or in lieu of keywords. In one embodiment concept is defined as a set of keywords or combination of keywords and topic words. Concept can be entered by user explicitly through a second field or through a text cue such as in “concept environment science” will translate environment science to keywords that depict the same automatically and thus create the search results. Concepts can be pre-defined by the system, and made available to advertisers and consumers alike. In an enhancement, advertisers and end users can create and refine concepts through interactive user interface, which will allow user defined concepts to be used by the system. Alternately, concepts can be automatically constructed, on some criterion, such as proximity of keywords where keywords are adjacent to each other in large or significant number of web pages in the web. In the example, all web pages dealing with environment science most likely have these two words appearing together, and thus a concept can be created. Keywords and Topics of these web pages will constitute the definition of the concept and when search is conducted, web pages will be picked not only for pages that contain environment science as keywords but also that contain the same as concept, where environment science will translate into several different keywords and topics that together constitute environment science as we all know it. Concept can also be referred to as thought in this context.

Idea and Theme Search—Searching by entering of an idea or theme instead of or in addition to keywords. In one embodiment, an idea is defined as a set of predefined concepts that represent the idea. Thus idea is a higher notion than the concept, and concept is a higher notion than the keyword. This enables search engine to construct an improved search model, where users may search for an idea, or a concept or a keyword and combinations thereof. To make the system useful, the ideas and themes in the system can be created by users and advertisers, by entering their ideas and defining the idea in terms of concepts, topics and keywords. This model allows users to create number of ideas and have these be used by the search engine. During search process, entry by user of these be may done using text cues or separate fields or may be pre-set for search session. In an enhancement, users may define ideas and instead of sharing with rest of the web, they may choose to selectively share or keep it private. This will let them store ideas for their own personalized optimization of search process. For example, in one embodiment user may enter “idea steam engine” or “theme steam engine” as the query, where search engine will look for all web pages that relate to ideas related to discovery and furthering of steam engines in the first case, while looking for all web pages that have steam engine as its theme in the second case. Where-as entering “concept steam engine” will present all web pages that describe the search engine. Entering “Steam Engine” in keywords box and defining a new idea called “design”, and then searching by entering design in a second text box will present those web pages that portray design as topic and have information on steam engines. Just entering “steam engine” as keywords may present a jumble of all web pages that have both these words and give higher priority to those web pages where the two words appear closer to each other. The last model is what prevalent search engine model is. Idea can also be referred to as theme.

Interactive definition of idea, theme, and concept: interactive definition of idea, theme, thought or concept is definable by end users. There are two possible models in this, first, users can enter an idea, theme, thought or concept, define the same, and release the definition for use by public at large, in which case, any one else can edit this definition and hence improve it over time. Checks and balances inherent in collective decision making will enable such definitions to reach an optimal level. This definition will be used by the search system to identify the best results for end users looking for such an idea, theme, thought or concept. A second method is for end users to define, and utilizing it for their own private search optimizations.

A derivative method is for advertisers to define an idea, theme, and concept, and use it only for advertising purposes. In one embodiment, advertisers define an idea or a theme, for example in forms of selection of keywords or phrases; and sponsor this idea or theme; system presents their advertisement or sponsored listing to end user when end user is looking for one or more keywords that are member of the idea or theme set. Advertisers will also be able to sponsor any idea, theme, concept or topic that has been defined by the end users collectively, thus enabling common interest advertisements to be presented for the community of users, and improving the beneficial value of such advertisements.

A derivative method is for end users to qualify third party pages or their own creations with an idea, theme, concept or topic via the search engine interface. Such qualification is optional and will require enough users to qualify a specific result for it to become statistically significant; and if so, will have higher priority in the search process than other methods of identifying idea, theme, concept or topic for a page or content or information.

Mixed-language or Colloquial language search: Users can enter a single language, such as English, or Multi-language or Mixed language, or Colloquial language words or expressions, and search is conducted using the best possible interpretation of such expression. An embodiment is use of English and Hindi words mixed, which is often used in many households in a large population in India, or for that matter combination of English and French, which is often used in French dominant areas of Canada.

Automatic Context search—with current time, current location, and other automatically captured attributes of user query environment are used for narrowing down the search scope and thus improving search results. Automatic Context Search allows special processing for time (t), location (lat, long, alt), age appropriateness and/or age-group target (G, PG, PG-13, R, X, or 13-19 years etc. ), media type (Video, Photo, Spreadsheet), language type (English, Hindi, Chinese), country (USA, India, China), Region (Region 1, etc. reflecting parts of a country or part/whole combination of several countries) etc. which allow the system to process search for information more meaningfully. System generates this information set for each of the web pages, and compares that to automatic context for user query, to produce more meaningful results.

Location Context: Position (lat, long., alt) and/or Velocity (v) and/or Orientation(o) of information consumer or user device compared to Position (x, y, z)/or Velocity (v) and/or Orientation(o) of information originator and/or of item of interest in such information. Relative velocity, relative position and relative orientation to be used to fulfill search requests which can take advantage of either or all of these (such as find me nearest taxi that is heading my way and is available for hire).

Media Context: Characteristics of Information Media or Media Element in a multi-media multi-device and multi-access environment, where information origination and communication influences the quality of such information (for example—a low quality photo from cell phone can suppress detail otherwise considered important).

Shopping Context: Recognizing that the search is targeted towards a purchase, special treatment to query is given to produce product oriented information.

Personal Relevance search—As no two users are alike, results for each user differ for the same query, based on system capture of user's specific interest, and intent etc. which is different between individuals as well as changes from time to time for the same individual. Present day search engines deliver same results to same query irrespective of who the inquirer is and therefore miss important aspect of search query. Personal Relevance overcomes this and hence improves the results that get targeted for every user and based on when such a user poses the query, and if available under what circumstances, to provide information of direct interest. The Personal Relevance search model is combined with Automatic context and other parameters to yield targeted results for every user and their query. This model requires user information to be known to the system by user entering the same or sent along with the query to be used for improving search results with user permission. The method is optional based on user request, and works in cooperation with topic or other information explicitly entered by user or with special or automatic context such as time, age of use, location of access device etc. to identify and present the best possible information. User may further indicate a specific profile under which the search is being done such as i.e. personal, professional, or social to help the system improve results. System may capture this information through explicit user entry or selection, or by user having preset such a selection, or user using a profiler tool or the system capturing such information over time, through user queries posed. Explicitly entered information, by user in user context will take higher precedence than the personal relevance, as user knows best. However, personal relevance model will avoid entering user city name again and again for local oriented queries and thus improve quality of results.

Target Device Context—Automatic identification of user device and its capabilities including display size, connectivity and local computing capability being used to determine the best suitable model of information and search features delivery by the system. Device Context utilizes characteristics of information consuming user device or access method, whereby originated information may contain more or less detail that are appropriate for the target device, and hence information may suitably be modified in real time to suit the target device. This implies that information presentation for a media center may be automatically adjusted for large screen display, where-as information for a personal media player may be down adjusted to suit its small display, at run time by the system, using display oriented pagination and available media reduction techniques. Likewise, such an adjustment may be done based on connectivity bandwidth and computation capabilities of the device, to ensure optimal use of device resources.

“Dynamic Relevance” Model—combines above methods in a single solution to create a “Dynamic relevance” model that brings together far more suitable result for the consumer intended requirement. The dynamic relevance model is inclusive of search scope reduction, and thereby improves the overall relevance of the search result.

“Static Relevance” Model computing as “Global Popularity Index” or GPI for information relevance across and based on specific source characteristics for web 2.0, and creating a multi-media multi-source relevance model across the various sources of information, to bring all the sources at par, from a user view point.

The GPI for static relevance is computed using: An all inclusive modeling of each of the static and dynamic web information sources in web 2.0 environment of global Internet as uniquely identifiable “information source” or “information node”.

The GPI for static relevance is further computed using: Modeling of Consumer Navigation, along various choices of URL paths indicated by embedded or explicit reference links (or URLs) originating from and leading to an information source of web 2.0 environment, and probability of traversal along such paths, being determined by Contextual Relevance of intended context of information by author, provider, creator or other, vs. desired context of information by consumer.

The GPI for static relevance is further computed using: Limited user patience modeling allowing user to backtrack, traverse sideways or start from an alternate starting point, if a specific information source is not very contextually relevant or otherwise of not much interest to user.

The GPI for static relevance is further computed using: Using law of diminishing returns along a path to show that probability of traversal needs to be compared with a threshold probability below which further traversal will not yield any meaningful information.

Improving the chances of uncovering information that may be deep down when more contextual similarity is identified, while reducing the chances of wandering, by limiting the traversal when contextual similarity is not identified.

Improving the chances of uncovering directly relevant information in smaller number of steps, of an equivalent present day search, where, overall time is reduced through reduction of number of queries that user takes to find specific information, with improved possibility of identifying most relevant search result directly.

Combining the above steps in a single method to lead to useful information relevance captured as GPI that can be computed ahead of time to consumers seeking such information, and therefore results in “Static relevance” model.

The “Dynamic Information Relevance” for “Web 2.0 information search and presentation” system is initially computed combining the “Dynamic relevance” models with the “Static relevance” models in a combination best suited for the query.

“Personal Relevance” is additionally applied if the user so chooses or opts for and is integrated within the “dynamic information relevance” method. This integration can be done in several different ways, one such embodiment is to carry out search scope reduction e.g. if a medical doctor is searching for virus, vs. a computer expert is searching for a virus could be two different personal relevance models. Another embodiment is to compute “personalized global popularity” for a query using “personal relevance” factors; this method is more compute intensive and may be possible in future when users and network computers can crunch such intensive computations tasks in real time. For present, search scope reduction is more performance friendly method.

Dark Web Search—search for web pages that are not linked or pages that appear too low in priority are presented separately based on not static relevance models such as links from important web pages but other relevance factors. Method of Web 2.0 search is extended to bring out the otherwise dark web pages by giving higher precedence to dynamic relevance model than static relevance model. Dark web has two components—web pages that are published but not linked to by any other web page, and hence never show up in any result since web crawlers tend to miss these; and the second is long tail web pages, which constitute most of the web, where web pages are linked but not by large web sites or important web sites, resulting in low priority on traditional search engine methods, and hence do not really show up even though such pages may contain useful information. The first of these cases is addressed, by traversing through DNS servers, to find registered domain names, and ensuring that a DNS driven web crawler, in addition to a links based web crawler, is put in action, which collects information on all such dark web pages. The other type of dark web pages are addressed by giving higher weights to dynamic relevance, which results in narrowing of search scope, and then applying static relevance model within the narrowed search scope, to result in capturing of any part of the dark web, reflected as long tail effect. Thus, in this dark web method, by creating a separate way of searching and presenting results for dark web pages, users can now look for relevant information contained in these pages.

Invisible Web Search—Invisible web consists of information provided by “Dynamic web” pages and “Web services” application interfaces provided by web sites to information. Such information does not get captured by traditional web crawler based model and fails to show up, or more typically shows up as catalog links and not as information, in traditional search engine and relevance models prevalent in the current state of art, leading to the effect of invisible web i.e. the information is there but we can not get to it directly from the search engine.

The method of Web 2.0 search breaks this down into three separate categories—(1) Dynamic Web—where content is computed by the web site or information provider upon web page request by users and the search methods can identify a universal interface to such dynamic content and thus compute this interface on demand or at periodic intervals; (2) Web Services—Where web site or information provider is advance enough to provide an application programmatic interface or API using one of the standard methods of web services publication, and the third model—(3) Invisible web—where the content or information is dynamic yet no universal method exists and no web services offering exists and hence such case is addressed by having the web site provider enter a script or function reference which is specific to that web site or web page in the search engine model through a user interface or search engine API, and have the search engine use this specific interface for that web site to compute or get information, in real time or near real time, as a consumer query is processed. The third situation is at present the dominant situation, since no universal interface exists and web services have yet to catch on in terms of their adaptation.

Dynamic Web Search—Increasingly more web pages are containing dynamic content which is computed or retrieved from databases in real time when-ever the web page is requested by a consumer. For traditional search models this poses a problem since the content of the web page is changing frequently or in real time based on character of the information and content. Such web pages are highly representative of the new web 2.0 environment and yet are not being serviced by traditional search algorithms, due to the changing nature of content. The method of dynamic web constitutes of identification of a web page as having or being dynamic web content page, followed by identification of a universal interface that the search engine can recognize by its signature and capture the interface for computation. An example of such a potential universal interface is the new RSS standard which is beginning to be supported by many web sites with dynamic content. In this case, by detecting RSS signatures on a web page, the new web 2.0 search method acquires the RSS service descriptor file in XML form, and gets ready to receive RSS feeds on a periodic basis, that constitute such dynamic information. RSS feeds contain channel and items, which change feed by feed and each feed received is processed by the web 2.0 search engine, and resulting information is made available immediately to consumer queries. Method is extensible to similar formats such as ATOM. A new proposed method called STI or Simple Text Interface is described below as a potential universal interface to dynamic web content, which presents a simpler alternative to complex web services APIs.

“STI—a Simple Text Interface”: An interface that is common for all search engines and online web site providers . . . as a universal interface for applications access i.e. all search engines and all consumer sites with dynamic content or real time information shall support the new STI universal interface, which is defined in form of simple HTTP/HTML format and is humanly readable. Currently web sites with search capability support some sort of HTML based interface, but it is not standard and not targeted to provide dynamic content. The new STI universal interface is simpler than web services API, which require programmatic interfaces and are therefore harder to support by web sites. In Web 2.0 search model, the STI is supported by a web site to service the dynamic web as universal interface, where Web 2.0 search engine can use this as universal interface to dynamic content, as STI becomes standard across all web sites and information providers to get dynamic web information on demand against user queries.

Another STI application is defined for search and other future applications, which allows end user interfaces such as web browser, search interface application or mobile device application to interoperate with Web 2.0 search engine. The Simple text interface or STI uses humanly readable input and output model, which the application can interpret both on search engine side and end user interface application side. This model is superior to present day http protocol only combined with cryptic letters as well as much simpler than web services SOAP model of WSDL based exchange; which is not human friendly. STI results are returned as mix of open web and paid web search in a standardized manner which the user interface software can display in its own way instead of a standard web page model.

Web Services Search—WSDL/SOAP/REST/HTTP/XML or other web services model are used for determining the best source of information for a user query. Application query is run for such web services based on user query, and information so retrieved in real time or near real time is presented to user, along with a link to get more detailed information, if the user should wish to get more details. If that not be the case, then dynamic web pages can only be addressed through an entry by web page authors into new search engine system interface, where they can upload a script or function which can be used by search engine to inquire the dynamic web page for information.

Web Services based Search=searching for services oriented web and capturing “service description” for getting relevant information against search queries by users; services range SOAP/WSDL to RSS to ATOM to HTTP/XML/REST and other emerging standards. The system therefore will permit search of dynamic content which is produced by web service application and information providers, and where search is conducted using the live access from the database of the provider through the web service API provided by such a provider, which must contain at least a minimum set of standard API.

Service Descriptor documents search—documents of WSDL, XML, RSS and other service descriptor formats are searched on web site during the web crawling action, retrieved, stored and indexed, along with associated properties based on service description tags contained in the document. Information is retrieved using these service descriptor documents against user queries at run time, as per prioritization computed using static and dynamic relevance methods for the same. One of the limitations of applications of this method is lack of availability of such services and corresponding service descriptors at web sites; however, that can soon be changed as web sites realize that the new web 2.0 search method can service this new model and thus make their content and information available to end users more easily without having to develop user specific applications, i.e. in a generic search oriented user interface. This can trigger a new wave of web services support, and thus improving the visibility of dynamic content.

“XML Documents Search”: XML is standardized model for data communication over the web as per W3C standards. XML documents are represented by four types of information—a set of customized or industry specific tags i.e. meta data, a schema or data dictionary defining the meta data tags, actual data for a specific instance or request for each meta data tag, an optional style sheet for presentation of data for each meta data tag or element. Search of data present in XML based documents, static or dynamically created, is carried out using the Meta data tag and corresponding data values. Keywords specified in search are compared to the Meta data tags and if a match is found, result of search is presented using the style sheet, schema for the tag along with its data well formulated for user viewing. This method enables search for information, and not just text; however, it is limited to only that information which is present in XML based ready to use documents. Searching for data which is stored in databases, on the other hand can be done by posing a query to data base, for the keyword matched Meta data tag in XML and getting the data value, and then representing that data to user properly formatted along with the corresponding tag as name and value pair. On the web, many web pages are being written in XHTML, which is well formed HTML as per XML standards; this is still HTML only and hence is processed as standard web page. However, if such a file contains XML itself, then the method described here is applied.

Live Acquisition of Information Model—Web services and other live information sources and capabilities are searched and service descriptors identified and added to the list of information sources for global popularity computation i.e. static relevance of the web service. At run time, when a user query is posed to the web 2.0 search method of 1, the web services that can provide such information are identified based on their service descriptors acquired earlier. Prioritization is done for each such qualified source based on the “dynamic information relevance” and the highest priority source or sources are then computed in real time or near real time (e.g. Pre-set delay), and information so acquired is formatted into web 2.0 information presentation format such as XML or XHTML or in the mobile specific variants and send to the end user, separately or combined with other content oriented search results. The source for web information is also identified and presented as a link, for additional information should the user so desire. This way, the method of Live Acquisition is able to service the users with information in real time or near real time, without the user having to take extra steps. The method requires permission from the service provider for acquiring information, and such permission is deemed to have been granted usually, if the service provider provides a service descriptor in public domain. Further, private or secure domain services can also be added to this method, by striking paid service agreements and charging the users or user agents or applications for such information presentation.

Automatic Web Acquisition Model—for frequently changing web pages, by having a search engine agent on every web site—a plug-in is provided which web site administrators can download and install that will inform the search engine using some form of web service of change in any web page on the site as soon as such change is made public along with other required information to enable up to the minute availability of changed information of the web page and corresponding relevance computing for end user queries.

Dynamic Web Acquisition: Improves or eliminates the traditional web crawl model by creating web server plug-ins for live alert of web page modifications on a web site. This results in reduction of redundant crawls, allows web page authors to reduce time for visibility to end users. This method can reduce load on the Internet that current web crawlers pose when they again and again crawl the entire web looking for changes in same web pages, even though changes may be far and few; while missing on the time critical information, until next iteration of crawl happens; as is evident this is quite unsatisfactory for consumer originated information where recipient consumers wish to have access to information right away. In some ways, the current web crawl method also makes present day search engines somewhat less sensitive to frequent modifications of consumer driven web content and hence somewhat obsolete in their present condition.

Mobile Search—Dynamic and Automatic context are used, along with topic, concept and time search models to provide best information to a mobile user through Mobile phones, Smart phones, Automotive PCs, Wireless PDAs, Ultra-mobile PCs, Mobile Game Consoles, Personal Media Devices and other emerging mobile devices etc. In this, having identified the results, mobile friendly information for each search result is presented. In one embodiment, each web page contains <mobile> tag which is captured by search engine and presented first, and only if the user wants more information that user clicks on the corresponding result link. In another embodiment, the mobile user agent searches first within web pages that have mobile friendly equivalents, such as those web pages with <mobile> tag, or new emerging mobile.yyyy.com or yyyy.mobi models; and if it fails then only the user agents directly or through the search engine, retrieves regular web page that are automatically modified for mobile friendly presentation. Mobile search combined with dedicated user interface creates a very powerful alternate model for the increasingly intelligent mobile phones, and makes search available to billions of consumers globally who do not have access to PCs and Internet.

Mobile Search—Search across mobile oriented or mobile and smart phone ready information to be provided on a mobile phone. The search model naturally takes advantage of the context information gathered from the mobile device such as location, time and user provided information to improve the overall result of search. The search is presented through integrated browse and search software, integrated with the mobile device, in an easy to use manner, and other improvements. Special mobile ready information may be provided by author under a new tag “<Mobi>” or as per standards under “websitename.Mobi” domain; or under mobile.websitename.com or similar web addresses, or automatically extracted by the search engine during processing and have it ready for mobile access by millions of user. The system may additionally provide automated content readiness for mobile viewing, by getting latest web page and reducing text and images etc. for mobile display and sending it to mobile phones for easy display without human intervention.

Mobile User interface improvements such as assigning key combinations e.g. “*1 or pressing **” can directly invoke integrated mobile web search software, instead of a web browser and users can directly enter queries. Queries can be automatically completed or users can be given dynamically updated list of words to reduce time to enter, or drive by using voice commands for those users who prefer voice. Today's mobile and smart phones are highly capable of such user interface but do not have the right software organization to achieve a harmonious and easy to user interface for search.

Mobility Factor based “On The Go” Search Model—A Mobility factor is defined as being dependent on user selectable parameters, and user can dynamically select the level of such a mobility factor to dynamically have part of the search locally executed on their mobile device to result in an “On the go” search, separating from a pure network based search of present day search engines. As the new “On the go” search model takes search engine and corresponding partial database to the mobile phone, it potentially eliminates the need to have central server storage of web pages, instead user goes to the web site directly from the mobile search database. Index table on the device may optionally also store “<info> and/or <mobile> and/or <mobileinfo>” tag information locally in the device in the Information Direct model, thus creating opportunity for user to do off-network searches. On device information is updated periodically over wireless network or synch based networks when manual or auto synch happens. This requires larger memory on the mobile device, such as those available on iPod or similar media devices and iPhone or similar smart phones.

Dynamic Information Relevance Method is applied to mobile search i.e. dynamic relevance and personal relevance are combined with Global Popularity Index method to compute dynamic information relevance model which then computes the final priority of which information sources of the web 2.0 environment need to be presented.

Mobile search devices dedicated for search and search related applications can be designed which simplify and therefore popularize mobile search. To further assist the mobile form factor, an author creates a mobile page or mobile content for each web page or web content, where such a mobile content is either contained in the web content or referred through a Url, to allow for retrieval of mobile content, even as the search results show regular content link. Further, search results may show previews of mobile content snippets, in place of web content snippets to expedite the process and reduce data and display requirements for the mobile device. Automatic extraction or pagination of web content by search engine for specific mobile device on demand is another enhancement that can assist this process. The web page construction process can be improved to help this automation.

SMS or MMS based search—in many developing countries including India and China, large population is under served in terms of PC or laptop based Internet, while mobile phones have permeated such population and are increasingly expected to become the main source of information acquisition. For such population, mobile search can be the way to be services and have access to global content and services available through web 2.0 search. Further, mobile users are adept at using SMS or text messaging in these countries, SMS based search model may be more quickly adopted, followed by mobile browser models. A new web 2.0 interface with SMS in and SMS out is provided which allows users to send short message based queries, and these are used in dynamic information relevance model to identify the best information source. Further, since the user may not have the capability of web browser or there may be a charge for it, the result of SMS search will be sent as Information itself, and not links to such information, as is the case with traditional search engines. This will allow users to receive meaningful information using mobile phone which is immediately useful (i.e. location wise, time wise, user profile wise etc.).

Smart devices search—new emerging devices including new generation game consoles such as Nintendo WII, Microsoft Xbox 360 etc. are increasingly capable of computation as well as Internet connectivity provisions. This opens the door for web 2.0 search capabilities to be delivered to end users through having browser capability or dedicated search user interface capability on the such a device. Display of such devices is usually a monitor or television, in large screen or wide screen format, requiring content presentation subsystem of search engine to detect the device and send content formats appropriate for such displays. Newer emerging devices, also include smart TVs, ultra-mobile PCs and smarter Wi-Fi phones such as the IPhone or Skype Phones which will be much more useful with support of Web 2.0 search on these devices.

Collective Wisdom Relevance Model—Collective wisdom of all users globally for a specific query or word, is captured by the system, based on which specific results they click through, and uses the “Time rate of click-throughs for keyword or collection of keywords”, to detect high interest result candidates. This information improves with time, as more data is collected for a keyword, yet stays highly responsive to peaks and valleys that occur as user interest strengthens or wanes as derivative of time. By measuring in real time, the time rate of popularity change for a keyword and search result combination, rather than cumulative popularity change, the new method is able to immediately detect high priority content, present it for the time it is popular, and then immediately reduce it to less popular in favor of newly emerged content; and does so without operator intervention. To be fair to somewhat older but still relevant content, the collective wisdom result may be separately displayed by the user agent as an option.

Collective Wisdom=collects and builds consensus of users as to what makes sense for relevance; this model allows catching of latest wave quickly while also allowing diminishing importance of out of favor information is an optional feature, which “dynamically computes time based rate of click-throughs of results for a specific keyword or keywords with dynamic context”, to determine the weight-age on search results. The system improves the model of gathering total number of user clicks on a search result shown often as most popular result, to gathering information for a specific keyword, and further, it computes the rate of such a click-through on any instant across global consumers. Such a method immediately creates a burst in the rate value for those items that catch consumer fancy, across all consumers, and present against a keyword, or keyword with dynamic context; while allowing out of favor items to become less important, as consumers would like to have.

Collective Wisdom: A new method for dynamic evolving model of computing relevance, based on what the consumers are liking for a specific word or a specific context across global web. System cold starts with some form of authored popularity or “Static relevance” model, and gathers real time data across all searches in an anonymous manner protecting user privacy and utilizes this data to influence authored popularity in favor of user popularity. The collective wisdom model allows system to do learning, and improve results as the system operates more. This leads to continuously improving results for the same query, with time and as more and more users search; surpassing any static ranking methods to represent authored popularity. Additional consideration towards timeliness leads to capturing the time rate for number of click-throughs or views globally of a particular result or link, as well as, cumulative number of click-throughs or views of a search result or web page, for specific context and/or keyword(s); monitored in an anonymous manner i.e. protecting user privacy, and used to improve search results. As a page becomes less relevant, it is reflected by weaning of collective wisdom and if a page gathers new or sudden interest or is a new page with lot of interest, it gains the favor of collective wisdom automatically. This model therefore automatically adjusts dynamic relevance of a web page for the same query in the same context.

Interactive interface for collective wisdom—one method extension to collective wisdom is for users to rate a result on a pre-specified absolute scale, or on a scale which is relative to other results. This interactive format, not only captures the click-through success time rate for a result but also allows end users to actually participate in the process by providing a rating; thus creating a second dimension on which collective wisdom can be measured and used for producing improved results, with a little additional effort by end users globally. Naturally such a rating is optional and hence provides only higher weight to results if so available. This makes an improved user experience, where end users are able to influence automatically computed results for collective benefit.

The “Dynamic Information Relevance” is further enhanced by integrating Collective Wisdom for “Web 2.0 Information Search”.

Automated Preview Model—web pages are automatically previewed in a short form when user does mouse over the search results reducing the need for click-through and yet providing a highly interactive and visual experience for the user (using technologies such as AJAX). With higher bandwidth and better graphics computing increasingly becoming available, especially with new operating systems such as Windows Vista being more capable of superior graphics processing, such an automatic preview can improve overall consumer appeal and give more information with less work. Such previews may include multi-media information if such is provided by author or in the target web page or in the target information source in the web 2.0 environment, such as dynamic web pages, user created web pages and web services. In an extended model, information from target link in any web page or search result can be shown in automatic preview model when mouse over event occurs, while mouse is still hovering. This model changes the way of users of web currently access web, in the sense, they first view a web page and then if they like a link, they click through to target. Instead now users can first look at automatic preview of the target information source, even as they are still reviewing the original web page or search result page, thus reducing false starts or false click-throughs for users. This is carried out in addition to or as an alternate to presenting search results of a word or showing advertisements for words during mouse over.

Results and Page Preview: For each link embedded in a web page, during mouse over a preview of the corresponding web page can be shown reducing the need for click through until user wants to the full linked page. This model can be applied to search results page as well as to web pages in general on any web site. Previews are snippets of web page or alternately mobile web page corresponding to main web page, which are shown as preview. Preview avoids clicking on web pages or search results which may be less appealing, maximizing probability of finding relevant result in one shot by user, and hence improving consumer satisfaction.

Multi-media snippets and previews: By storing snippets and previews of multi-media web pages and contained media elements, a true multi-media search results page is presented going beyond present day text only results. Mouse over models to show preview of a multi-media web page to for more interactive experience and improved results review.

Global Advertisements Model—for keywords search, where advertisers can not only select keywords but also geographies and/or demographics and bid on the various combinations thereof. The search engine upon a match of the selected combination presents the corresponding advertisement or sponsor information for global consumer base. A partial match may be used if in case no or only few sponsorship exists for a full match. In other words, “Global Advertisements : A search word or term or part of a multi-word term can be either sponsored for local/country relevance or global/world relevance; thereby creating opportunities for advertisers to show their sponsored links either in their local/country context or global context”.

Concept, topic, Idea, Location, Product or Device Advertising Model—Concept, Topic, Idea, Location, Product, or User Device and other special cases as above, are used for more targeted advertising in addition or instead of keywords—a concept advertisement for example may automatically cover many keywords, and an idea advertising automatically covers many concepts, which in turn may cover many more keywords. Whenever any of these keywords or combination is searched for, advertisements are looked up and presented which are relevant to not only keywords, but also to concepts and ideas that encompass the same. Likewise, some user device and connectivity combination may be more capable of delivering rich advertisements, while others may not. Advertisers can select the device capability and advertising type combination model to improve delivery to end users. Concept Search and Advertising: In one extension, A concept is defined as set of keywords or keywords and topic words; users can enter concept for searching and system automatically translates into the corresponding set of keywords and keywords and topic words. Likewise, along side keywords, advertisers can sponsor concepts, topics, time range, location, ideas, product types, etc. which can be used for more user interest specific advertisements and sponsored links; in addition to current state of keyword based advertising.

Socially appropriate advertising model—Advertisements are filtered based on appropriateness factors associated with a specific user, query or user situation, combining appropriateness information with other dynamic relevance information to create a socially appropriate advertising model. This method extends to child safe Internet search solution for based on age group and related appropriateness indicators of user, and may be so controlled by a parent through their own user interface.

“Dynamic Information Relevance” based advertising—Advertisements and sponsorships are searched in an advertising database for a user query parallel to and similar to information search by applying dynamic relevance models in addition to the static relevance methods. Such a targeted advertising is presented to users sorted based on highest bidder model in auction oriented advertisement pricing system. In one variation, the advertising price per show or click-through is fixed, and not auctioned, and ads show up purely based on relevance to user.

Dark Keyword Advertising: In present state of art, keywords based advertising is carried out through identifying keywords that are most used by users, and having advertisers bid on these keywords. While the model is useful, it misses out on a larger number of words or combination of words that users can search in the entire word list. This set is defined as dark keyword set. The keywords in this set are significantly larger in number, have moderate to low frequency of occurrence in user searches. The new method comprises of advertisers being presented with suggestions for such dark keywords, and hence allowing them to win bids on much lower price points than the more popular words. Given the size of web, which is growing, and size of overall advertising base for the Internet which is also growing, new set of dark keywords opens a whole new area for advertisers, and creates larger potential for finding relevance advertisements, sponsored sites and like for a larger consumer base. Plotting a curve of keywords popularity in searches and average bid price, the resulting curve has a long tail, and area under the dark keywords i.e. much of the tail, is much larger than the early portion of the curve, showing the overall benefit of this method. One embodiment of this method is to make specific suggestions, potentially through a user interface or through traditional sales, of such dark keywords to advertisers and partner sites for them to take advantage of when they are placing an advertising order.

Multi-media advertising: By accepting multimedia short messages from sponsors and advertisers, the system can show such multimedia short message based sponsored global advertisements for both visible and dark keywords. This method enables more visually appealing advertisements without significant space or bandwidth requirements, as such multimedia enables sponsor messages can be shown in side panel or frame of search result, by ensuring that the multimedia message size is limited to a pre-specified height and width and is suitable for unobtrusive rendering in the sponsored links frame or panel of search result web page or search integrated user interface application. In case of mobile search, the message may be shown as a thumbnail suitable for small form factor or mobile device, where as in case of smart televisions or game console monitors, this may be shown in a larger frame, for distance viewing.

Sponsored Web: Method of sponsored web builds on various advertising models but instead of applying these to sponsor created messages and sponsored links, the method of sponsored web applies it to any search result. This method enables advertisers and sponsors to sponsor any search result or sponsor a link to an independent and presumably neutral content created by either consumers, or by service providers or professionals, which in some way promotes the advertiser business goals without it having been written or provided by the advertisers themselves. Sponsored web allows presentation of both open and sponsored web content for web 2.0 search results through web, mobile, smart devices as well as application API. Sponsored web is particularly useful for SMS or mobile search, where there is really no room to display any sponsored links or advertiser messages, but since sponsored web results are really independent these may be presented in a mixed model with open web, as per dynamic information relevance model.

The user interface embodiments of above solution can target specific user segments and specific device choices which the users may use including but not limited to the following:

A user interface and/or user software for search, with its variants for web browsers, Windows PCs, Mobile Phones, Smart Phones, Media Centers, Gaming consoles and personal media devices.

A web based user interface which presents an interactive user experience for capturing inputs for search for dynamic context oriented query and presenting results back on the web using various methods of Web 2.0 information search and presentation.

A mobile user interface which is accessible from mobile phones, smart phones and mobile PCs over wireless to capture inputs for various methods of Web 2.0 information search and presentation.

A media center or television oriented user interface which presents on a television friendly manner i.e. for large screen distance viewing, and capture of inputs using remote controls, wireless keypads and wireless game controllers.

An ultra mobile and other handheld PC oriented user interface which allows user to use touch pad for inputs for various methods of Web 2.0 information search and presentation, make and share models.

A game console oriented search interface which can operate within or without the game console specific Internet based service model to search within a game or combined game and its relationship with outside world.

A media player that can receive media content over the Internet, over satellite networks or other, but also ability to communicate the user query back to the service for such content to be received.

A user application software which presents a text box for keywords or terms and phrases entry, along with another text box and context, topic, time, idea or similar inputs that narrow the search scope or improve dynamic relevance of search results.

A user application software which presents search results for both keywords and keywords in specific context, under two different windows or tabbed panels, to allow user to have quick access to both types.

A user application software which has multiple windows/tabs/panels—one for each type of media in a multi-media search, such as for web pages, videos, photos and like.

A user application software which allows user to retain previous search results and provide a back and forward button or similar user interface to move from search result to search result, in addition to normal browser back navigation.

A user application software which permits mobile oriented content presentation on mobile and handheld mobile PC devices, in a manner which suits the display, computing and wireless connectivity.

A user application software and corresponding search engine optimized interoperability system, which permits fast search mode, i.e. search results are continuously updated as user enters letters for the keyword. This dynamic search model permits to search for words starting with partially known letters or partial words.

Other emerging user interface, application, application agent, device or device agent, system or system interface that may come about as a result of implementation of the claimed invention.

The above description and embodiments are illustrative of the invention and do not limit the scope of applicability of the invention and new embodiments of the invention which can be implemented through current and future state of software, hardware and data communications design, development and delivery tools, operating systems, platforms, devices, equipment, computers, mobile phones, mobile computing devices, wireless and wire-line data and entertainment networks.

### BRIEF DESCRIPTION OF SEVERAL VIEWS OF THE DRAWINGS

FIG. 1 presents one view of the current state of web 2.0 from users view point.

FIG. 2 presents some consumer benefits for new invention for web 2.0 search.

FIG. 3 presents some advertiser benefits for new invention for web 2.0 search.

FIG. 4 presents the multi-part relevance algorithms leading to “dynamic information relevance” that work together or separately as per user preference to determine the final search result for user query. Algorithms marked dynamic are computed upon query and algorithms marked static are computed upon collection or acquisition of data from the web. Only exception is live acquisition method where relevance of source of information is computed a priori which then is used at query time to get dynamic or live information.

FIG. 5 shows that “dynamic information relevance” can be combined with various advertising models to result in more targeted advertising benefiting both consumers and advertisers, and may potentially be rewarding for authors of content.

FIG. 6 shows one embodiment of the invention as a high level software system architecture. This architecture is not limiting the invention but rather is illustrative to better understand the invention and as to how the invention may be realized by a competent team of software engineers.

FIG. 7 shows one embodiment of the invention for network system architecture. This architecture is not limiting the invention but rather is illustrative to better understand how the invention may be realized by a competent team of software engineers.

FIG. 8: Sample search illustration with Sponsored web results mixed with Open web search results. [I-1]

FIG. 9: Sample search illustration with Sponsored web results presented in a separate panel.[UI-2]

FIG. 10: Sample search illustration with pop-ups being used for sponsorship. [UI-3]

FIG. 11: Sample user collaboration illustration where users define ideas, concepts or assign ideas, concepts etc. to existing web content to improve search.[UI-4]

FIG. 12: System capture of search results click-thru to get live data on collective wisdom and use of the same to provide usage based search relevance, as opposed to static search relevance, with optional rating of results by users in combination with collective wisdom. [UI-5]

FIG. 13-left shows illustration of mobile search user interfaces, with optional pop-ups if device permits. [UI-6]

FIG. 13-right shows another illustration of mobile search user interfaces, with optional pop-ups if device permits.[UI-7]

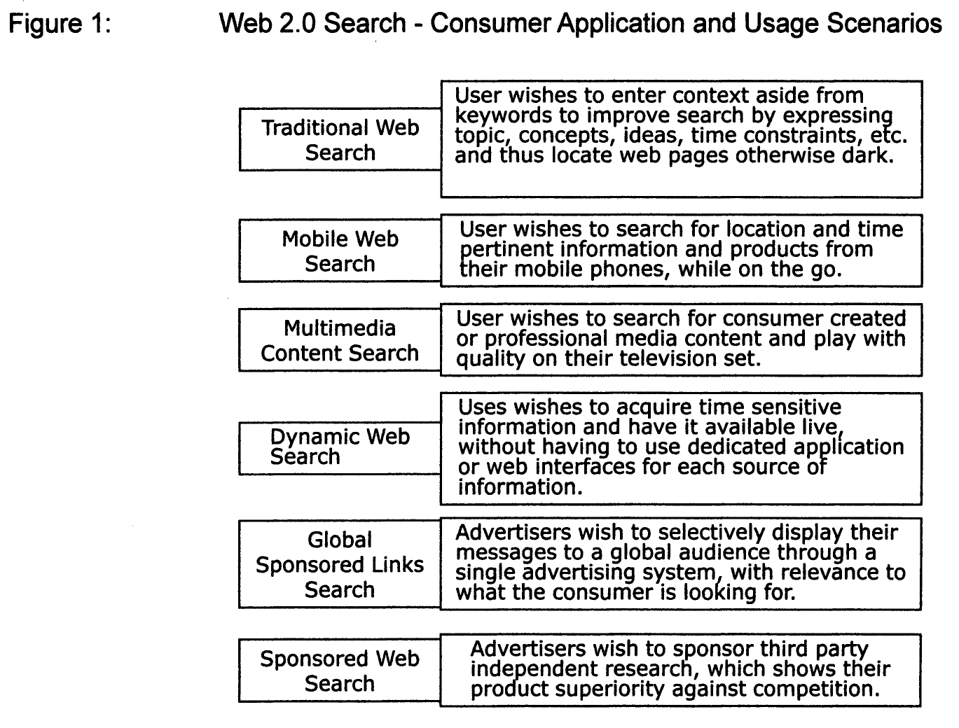

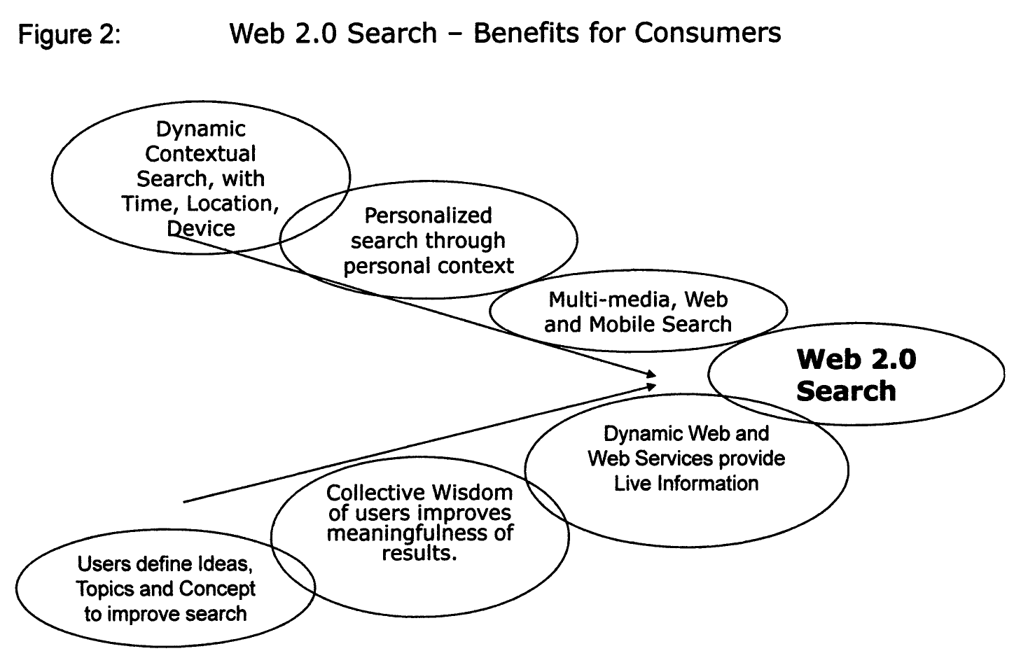

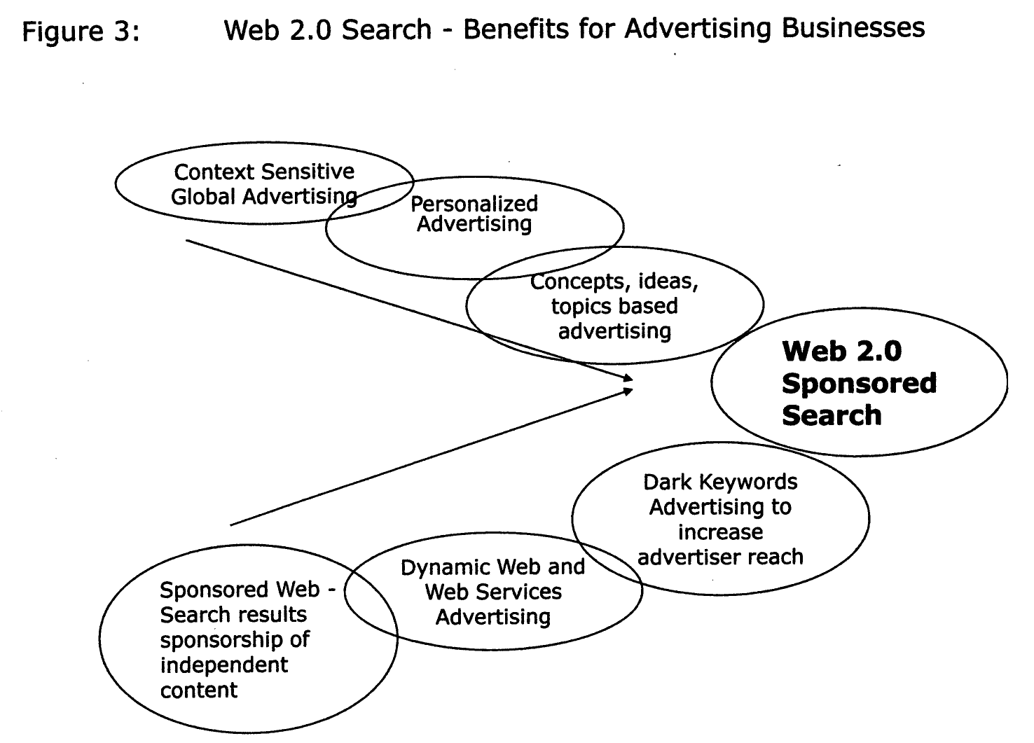

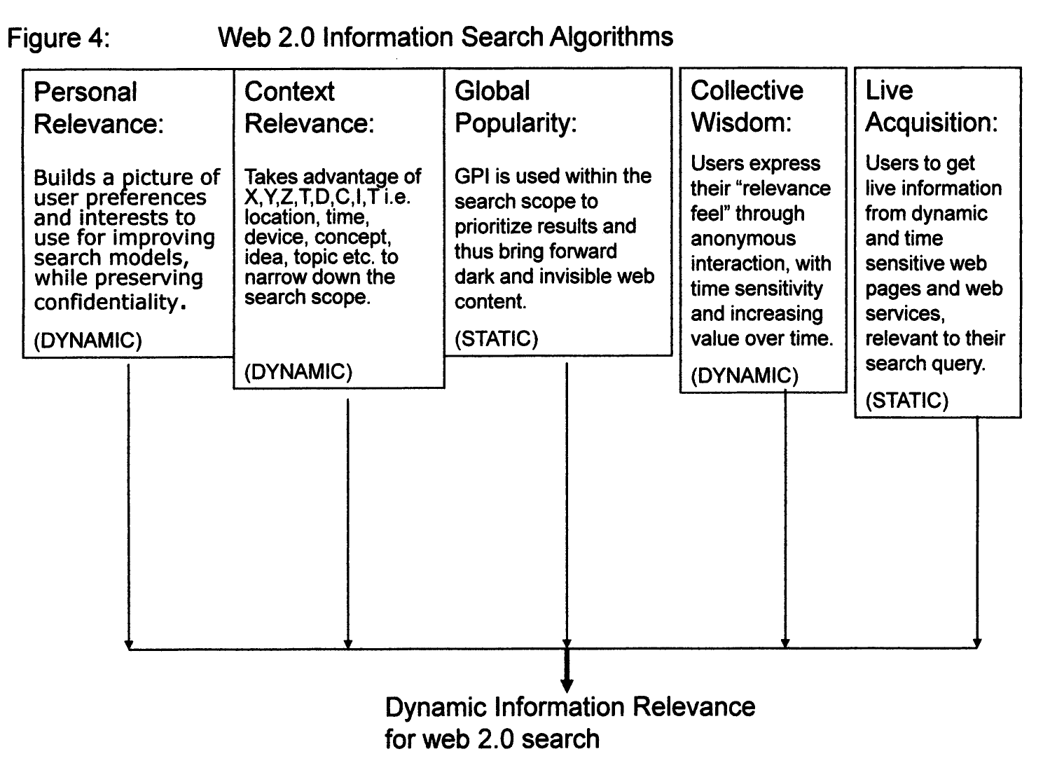

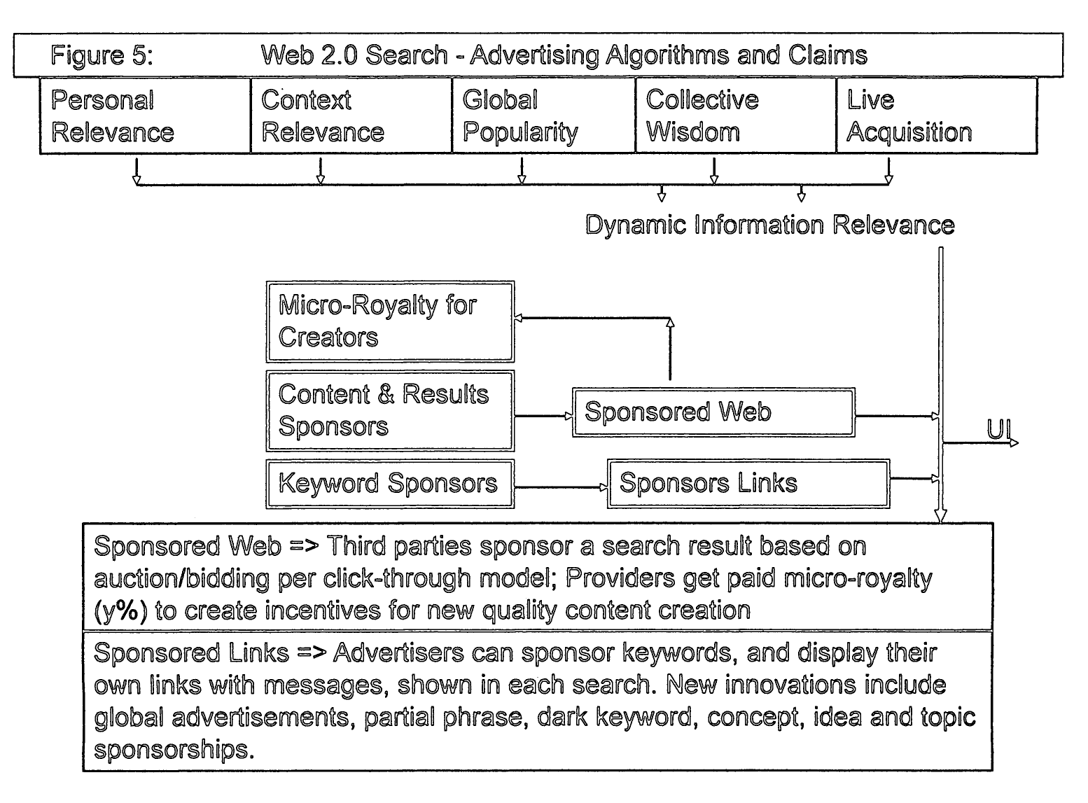

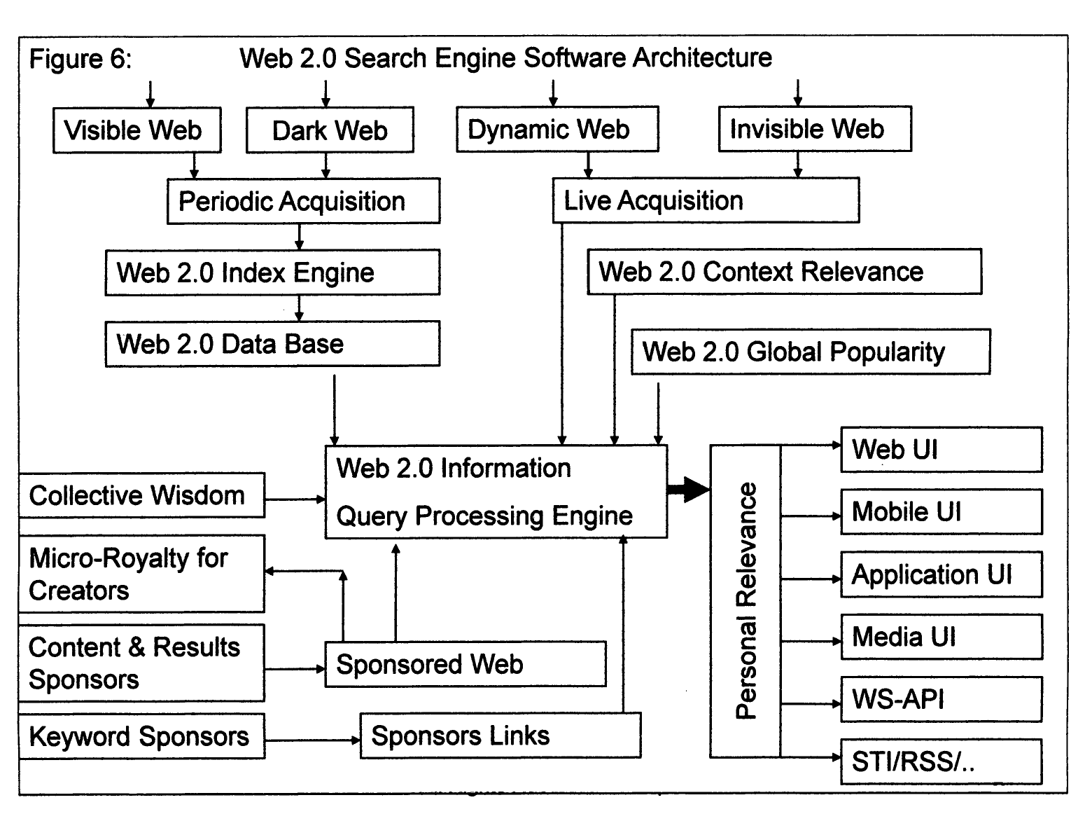

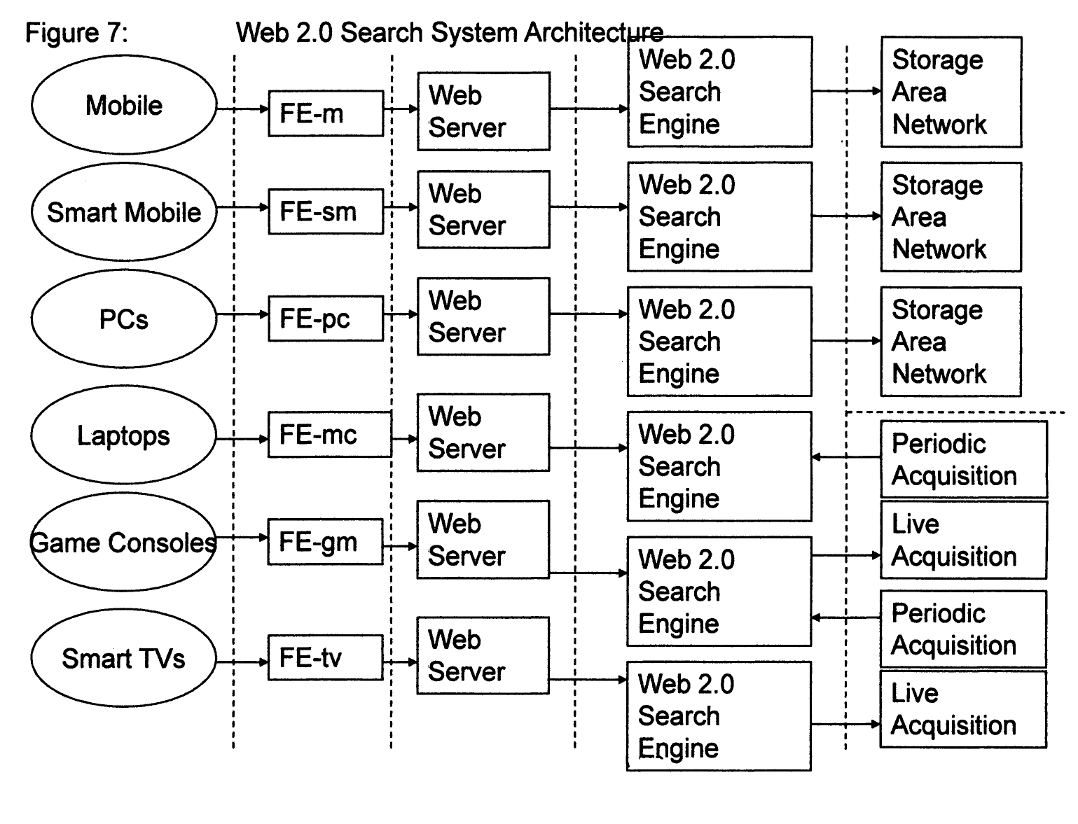

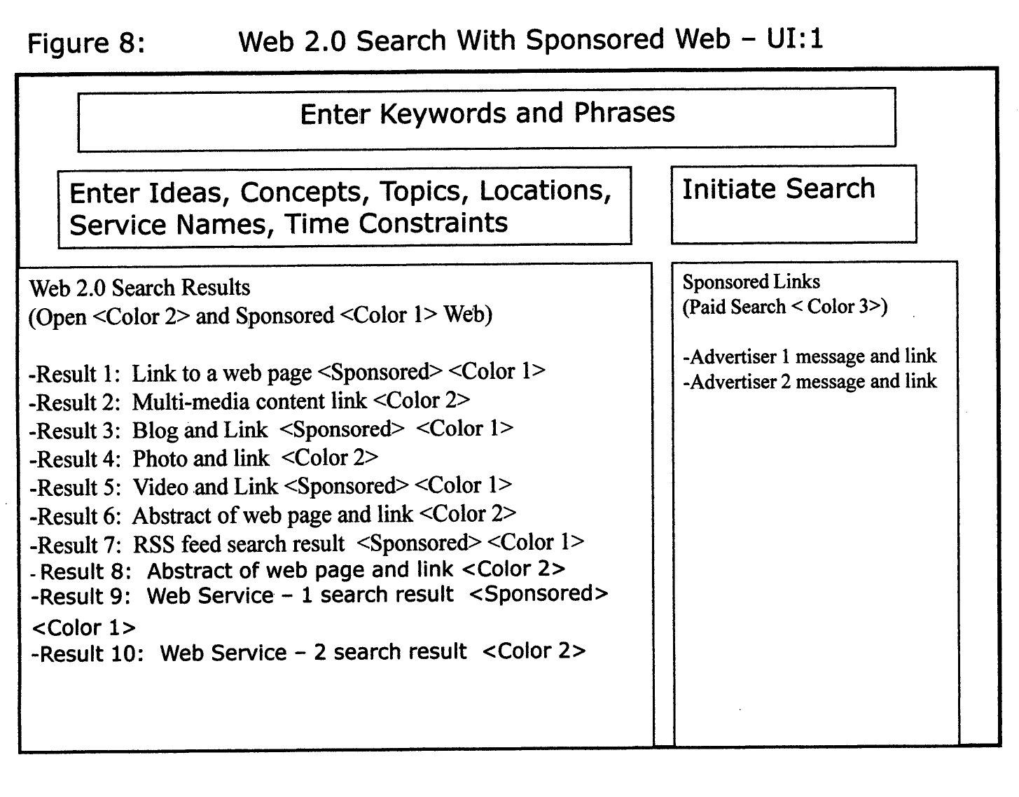

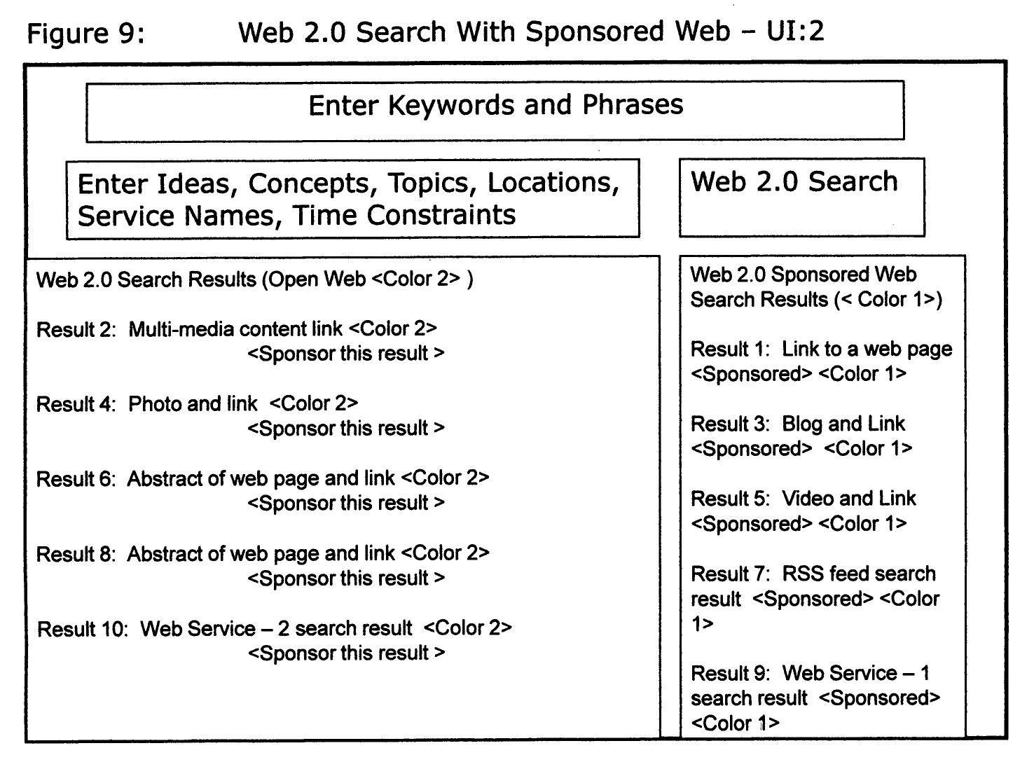

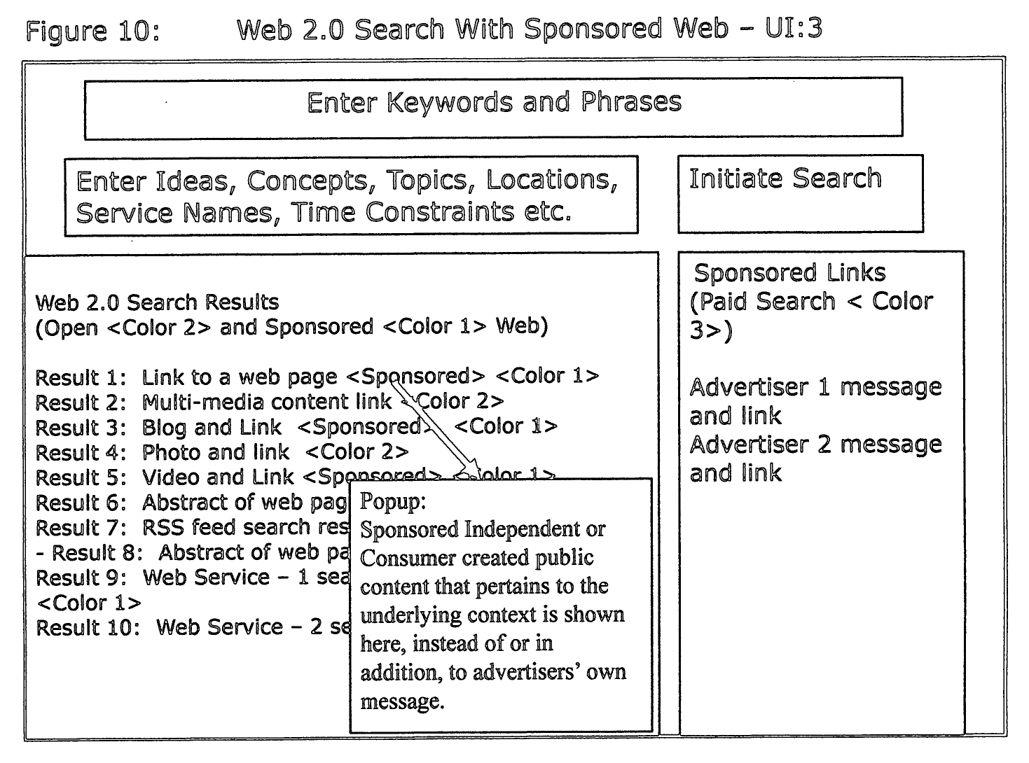

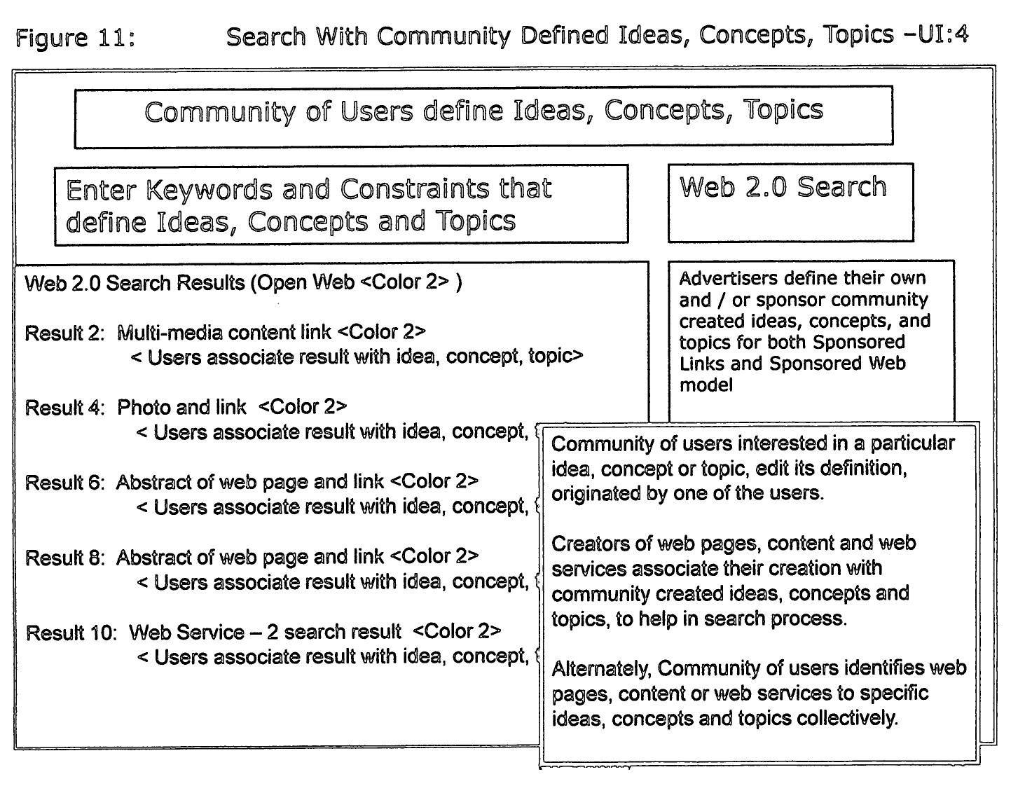

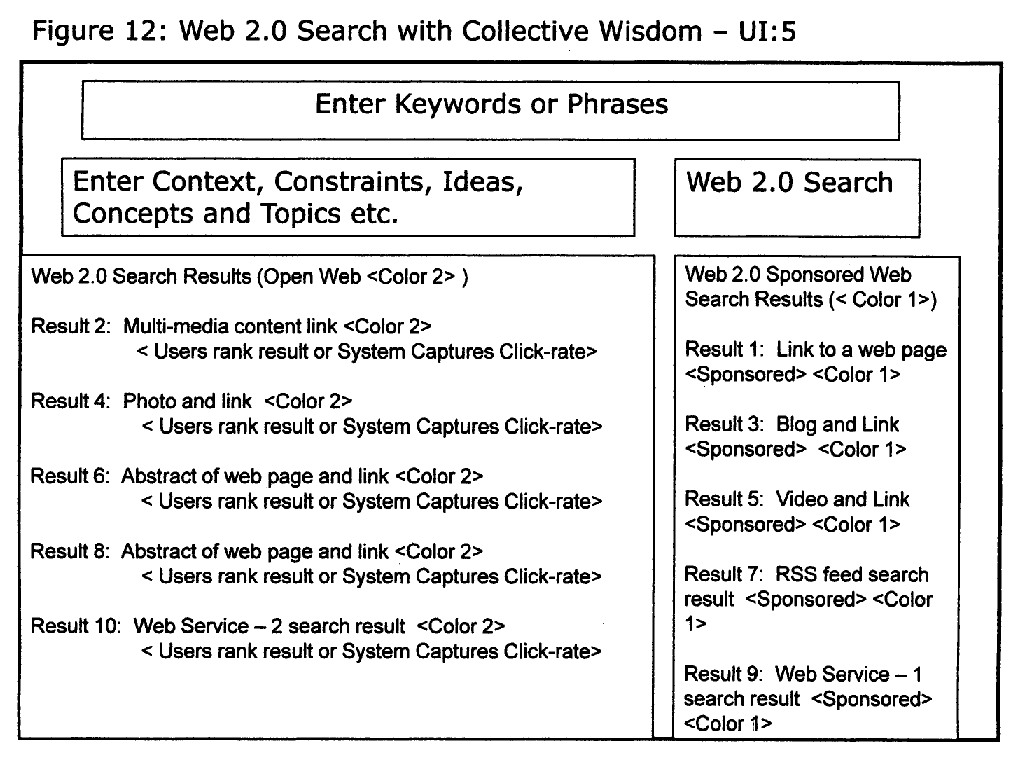

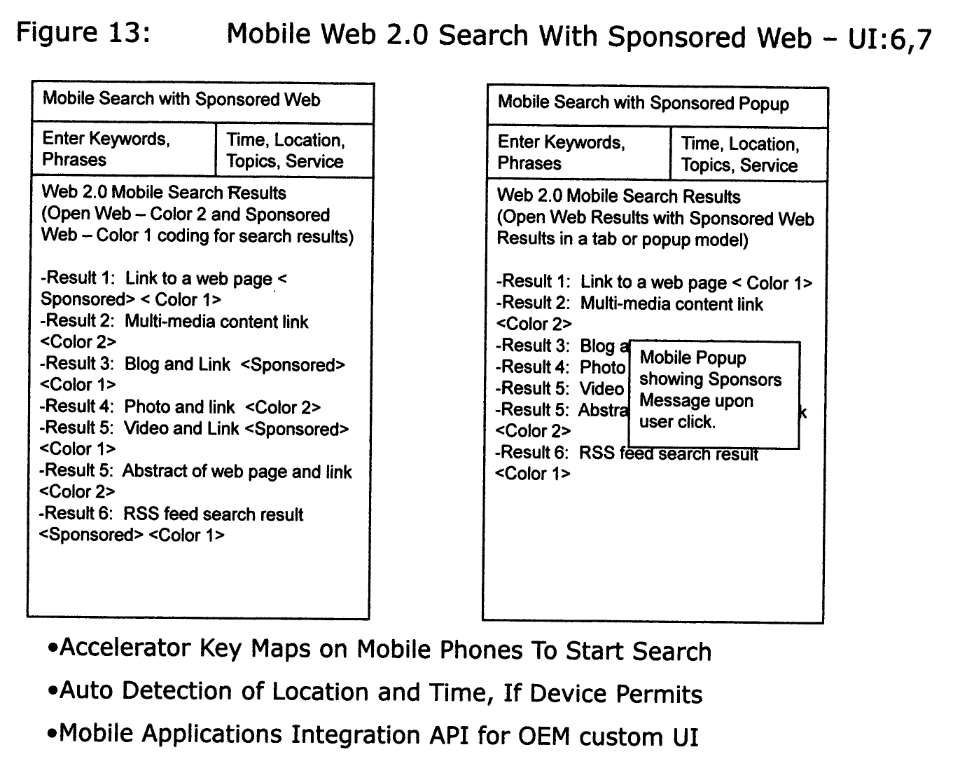

What is claimed is:

1. A system, method and architecture arrangement called “Web 2.0 information search and presentation” consisting of:
“Web Search”,
“Multi-media Search”,
“Mobile Search”,
“Content search”,
“Services search”,
“Applications search”,
“Search applications” and,
For information and content addressing the new:
“Consumer =Author” model,
“Static web”,
“Dynamic web”,
“Invisible web”,
“Dark Web”,
Other emerging models of the web and,
With information prioritization utilizing:
“Dynamic Information Relevance” consisting of,
“Dynamic relevance”, determined by,
“Context” comprising of:
Author context,
User context,
Query context, and,
“Themes”, defined as,
“Concept”,
“Idea”,
“Topic”,
“Themes”, and,
“Query” defined with one or more of:
“Keywords”,
“Phrases”,
“Language constructs”
“Expressions”,
“Constraints”,
“Time”,
“Location”,
“Device”,
“Appropriateness”,
Other relevant attributes and parameters, and,
“Static relevance” determined as
“Global Popularity Index” for information relevance and prioritization (or GPI),
“Personal relevance” of system user, determined with one or more of:
Private and public information,
Historical information and data,
Personal, community or public interests,
Professional and work interests,
Personal context information,
Query context information, and,
“Collective Wisdom” models, capturing:
Local and global user search and result click-through,
Utilizing click-through global data,
Click-through frequency and time rate of change,
Real time update of search prioritization,
Natural elimination of unwanted information, and,
Computed for each “Information Node”, including
Global web, mobile web and user private and public contents, and,
Web services, software as a service, web API and,
Other form of dynamic services providing data or content or applications
Delivered globally, combined with one or more of:
“Sponsored Web”,
“Global Advertising”,
“Thematic Advertising”,
“Dark Keywords Advertising”,
“Personalized Advertising”,
“Pay-Per-Search”,
“Pre-Paid”,
“Applications service” models, and,
Providing:
“Global and Local Access” models with one or more of:
Consumer or Enterprise environment,
Computing, Communication, Mobile, Television, Media and/or Smart devices,
Wired, Wireless and Mobile Internet or other data networks,
Web browser, Mobile web browser,
Integrated search and/or Navigation user agents or,
Integrated application agents, with search and other application integrations,
Mobile applications and Smart Device Applications,
Creation, transaction, commerce or sharing applications,
Search based consumer and business applications through one or more of:
Standardized search API,
Simple text API (STI),
Web services API.
